(19) United States
(12) Patent Application Publication
(10) Pub. No.: US 2022/0012674 A1
(43) Pub. Date: Jan. 13, 2022

(54) VOICE BASED PROOF OF DELIVERY FOR PACKAGES

(71) Applicant: Lynch Marks, LLC, Berkeley, CA (US)

(72) Inventors: Peter Reed MARKS, Berkeley, CA (US); Nicholas Charles ADAMS, Berkeley, CA (US); Joshua Ryan SCORCA, Berkeley, CA (US)

(73) Assignee: Lynch Marks, LLC, Berkeley, CA (US)

(21) Appl. No.: 17/370,876

(22) Filed: Jul. 8, 2021

Related U.S. Application Data
(60) Provisional application No. 63/049,329, filed on Jul. 8, 2020.

(51) Int. Cl. G06Q 10/08; G06K 7/14; G06K 7/10

(52) U.S. Cl. CPC G06Q 10/083; G06K 7/10297; G06K 7/10366; G06K 7/1413

(57) ABSTRACT

Systems and methods for a package delivery person's device for receiving and reporting a voice confirmation of a package delivery is described. In an example, a package label is scanned, by an operator using a portable scanning and communications device, to identify the package and begin the delivery confirmation process. A time-limited audio recording of a recorded voice proof of delivery that records audio for a determined short period of time is recorded, where a duration of the time-limited audio recording is configurable. The time-limited audio recording is stored at the portable scanning and communications device and is sent from the portable scanning and communications device to a central storage.

### CROSS-REFERENCE TO RELATED APPLICATIONS

This application is related to and claims priority to U.S. Provisional Patent Application No. 63/049,329, entitled “VOICE BASED PROOF OF DELIVERY FOR PACKAGES” filed on Jul. 8, 2020 with Attorney Docket Number 9260-V0001, which is assigned to the same assignee as this application and the teachings of which are herein incorporated by reference in its entirety.

### FIELD OF THE DISCLOSURE

The present disclosure generally relates to managing delivery packages, and more particularly to collecting a voice proof of delivery when custody of a package is transferred.

### BACKGROUND

In the package delivery process, to obtain a Proof of Delivery (POD), the person ultimately receiving a package usually signs for the package to acknowledge receipt of the package. Historically this has meant that either the recipient must sign a piece of paper acknowledging receipt or have their signature captured electronically on a device such as an iPod, iPhone, iPad, or other piece of hardware.

This conventional process may result in the following:
The electronic device or stylus or pen is handed to the recipient for capturing the signature. Some persons prefer to avoid handling object from other persons for various reasons. For example, during periods of health concerns such as circumstances encountered during the COVID-19 pandemic, people prefer to avoid touching things that have been handled by another person.
The signatures provided by the recipients are often illegible or incomplete (simply a “mark” is put in the signature area on the electronic capture device) and may not serve as a true POD that can be used to reliably identify the recipient. In some cases, a person may “forge” the signature of the recipient.
In cases where a signature cannot be captured, it may be time-consuming to record why a signature was unavailable and/or where the package may have been left (typing takes time and is difficult on many devices). A picture of where the package has been left can be helpful, but in certain environments pictures are not allowed, such as inside of office buildings, law offices, banks, etc., where sensitive information could be captured in the background of a photo.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 illustrates package delivery workflow and data collection activities, according to an example;

FIG. 2 illustrates a proof of delivery receiver user interface, according to an example;

FIG. 3 illustrates a package delivery process, according to an example;

FIG. 4 illustrates a voice proof of delivery packet creation process, according to an example; and

FIG. 5 illustrates a block diagram illustrating a processor, according to an example.

### DETAILED DESCRIPTION

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly and not necessarily mechanically. The term “configured to” describes the hardware, software, or a combination of hardware and software that is adapted to, set up, arranged, built, composed, constructed, designed or that has any combination of these characteristics to carry out a given function. The term “adapted to” describes the hardware, software, or a combination of hardware and software that is capable of, able to accommodate, to make, or that is suitable to carry out a given function.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The below-described systems and methods provide an alternative to capturing a signature upon transferring custody of a package from a delivery person to someone else. These systems and methods provide an ability to capture a small voice clip (recording) of the delivery process, a voice proof of delivery (“VPOD”). This eliminates a need to physically touch a device as is needed when giving a physical signature, is more deterministic of who actually received the package (less easy to forge than a signature which may just be a “mark” on a piece of paper or electronic device), and is faster than trying to manually write or type notes about the delivery process onto an electronic device.

These systems and methods address concerns regarding the security of using VPOD. Potential concerns include questions regarding whether the voice clip can be stolen and re-used such as to falsify other deliveries. In some examples of these systems and methods, the data file holding the Voice Proof of Delivery is encrypted and is uniquely attached to or associated with a single transaction so that the same data file couldn't be copied and used as a Voice Proof of Delivery for another transaction. In some examples, a combination of a unique identifier that is assigned to each package and the date/time stamp of the recording is assembled with the voice recording. In some further examples, an integrity verification value, such as a digital signature or other integrity verification hash value, is calculated over that assembled data in order to further verify the authenticity and correctness of the data. In the present discussion, an integrity verification value is able to include one or more of a digital signature, an integrity verification hash value, any other value that is able to provide a level of integrity verification that may or may not be considered robust, or any combination of these. That integrity verification value is then associated with the assembled data to allow authenticity verification of the data and ensure that the assembled data has not been tampered with, such as by changes to the package identifier or date/time stamp.

Concerns associated with the audio recording process capturing other sensitive audio data/information (similar to the images in the background of a picture) are mitigated in these systems and methods by limiting the time of the recording, such as to 5 seconds in an example, or the quality of recording by, for example, lowering its sampling rate.

The below described systems and methods are able to advantageously use voice recording in various stages of package delivery workflows. These voice recordings are can facilitate the taking of “notes” around any particular action taken on the portable scanning and communications device, such as an iPod/iPhone/iPad, and is much faster and more accurate than trying to type in information. Discussions of several such examples follow.

In some examples, audio notes describing things associated with the package delivery are able to be recorded during the original package receiving process. Examples of such notes include “package damaged on the upper left corner,” “part of 3 box delivery,” etc. In some examples, voice-to-text could also be used to fill in text data in forms that receive text input describing the consignee and consignor and the carrier.

In some examples, audio notes are able to be recorded during the internal package processing step. Voice notes about the process could also be helpful, such as “package stored in section B,” or “door was locked, so I couldn't deliver the package.” In some examples, these voice notes may not be “searchable” since they may be assumed to contain details that would not typically be searched for, but used for future reference should any questions about a particular package arise.

The present disclosure is directed in an example to a handheld portable scanning and communications device, e.g., a “package delivery person's device,” that is used by a package delivery person who delivers packages or other articles, including letters or other items. The handheld device allows the delivery person to record a voice message from the person to whom the delivery person gives the package. This voice message confirms that the person received the package. This voice recording is able to replace the conventional handwritten signature usually provided to a delivery person. The use of a voice recording eliminates the need for a recipient to touch or contact a handheld device or sign a piece of paper.

The handheld device operates to automate several functions of the delivery process. The processing by the device implementing the invention starts when the handheld device scans a package label. In an example, scanning of the package label is performed by a device by taking a picture of the label. The handheld device determines its location, and thus the location of the delivery person, by interacting with location markers that are located at various locations in the building. Such location markers are able to be bar codes affixed to walls at known locations in a building, short-range radio transmitters such as Near Field Communications (NFC) or RFID devices, Bluetooth devices or Wi-Fi hotspots, or anything that the handheld device can interact with to uniquely determine the device's identity to correlate the device with that identity with its known location. The locations of each location marker are stored in a database to allow the handheld device to determine its location. Locations of offices near the determined location can be used to identify the person that is receiving the package.

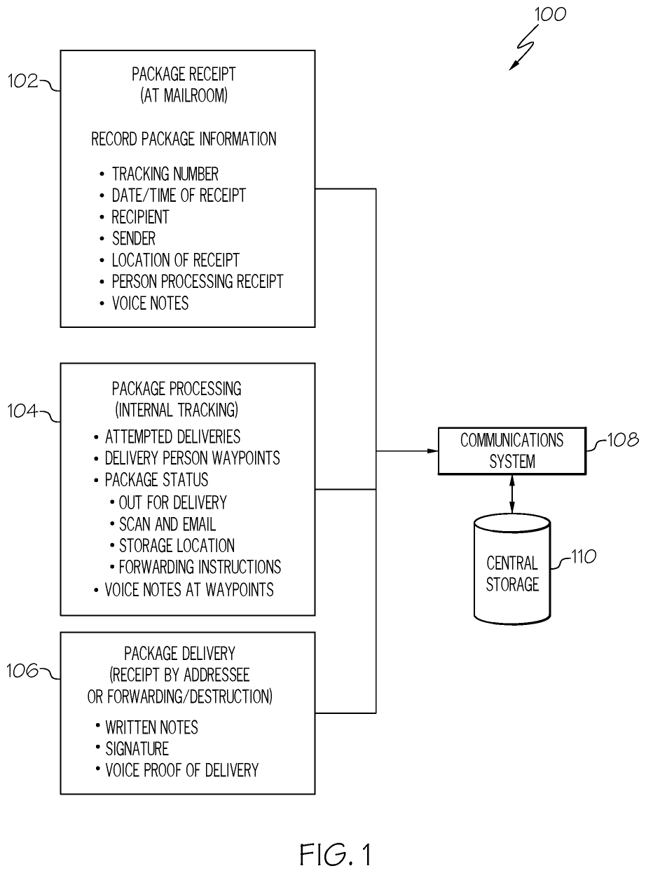

FIG. 1 illustrates package delivery workflow and data collection activities 100, according to an example. The package delivery work flow and data collection activities 100 depicts three (3) stages of processing performed in the course of delivering a package and also example data items that are able to be collected at each of those stages. The package delivery work flow and data collection activities 100 depicts a package receipt stage 102, a package processing stage 104, and a package delivery stage 106. The following uses the example of a package being delivered to an addressee. It is to be understood that the following concepts are readily applied to any type of object to be delivered, such as a letter, envelope, objects of any size, a set of any number of separate objects that are to be delivered to an addressee, other objects to be delivered, or combinations of these. As is generally understood, the package delivery workflow and data collection activities 100 depicts processing in an example that is performed for each package that is to be delivered to a person in an organization. In further examples, the workflow and data collection associated with the delivery of a package is able to include fewer elements or more elements than are depicted in this example.

The package receipt stage 102, in an example, is performed in a mail room of an organization and includes obtaining and recording various pieces of information about the package to be delivered. The package receipt stage depicts recording data items for each package that include a tracking number, a data and time or receipt of the package at the mail room, an indication of the recipient of the package, an indication of the sender of the package, the location of receipt, such as which mail room or other location to which the package was provided and received by the organization, the person who processed the receipt of that package in the mail room, and voice notes regarding receipt of the package. This information is able to be obtained by any suitable technique, such as by one or more of entry by the person processing the receipt of the package, electronic transfer of some or all information from a shipping company or other source, other techniques, or combinations of these.

The package processing stage 104 depicts the workflow and data collected for internal tracking of a package while the package is being moved through an organization to the addressee or final recipient of that package. Various data items regarding the status of a package are collected during the package processing stage 104. The depicted package processing stage 104 include obtaining and recording data that indicates one or more attempted deliveries to the addressee, storing way points within a building that the delivery person passes on the way to delivering the package to the addressee, the package status at one or more points in time such as that the package is out for delivery, has been scanned and the scanned information e-mailed, locations at which the package is being stored, forwarding instructions for the package, and voice notes from one or more times and situations that occur during package processing. This information is able to be obtained by any suitable technique, such as by one or more of entry by the person processing the package, electronic transfer of some or all information from an automated information collection system or other source, other techniques, or combinations of these.

The package delivery stage 106 depicts the workflow and data collected in the course of delivering the package to that package's addressee. Various data items regarding the status of a package are collected during the package delivery stage 106, including obtaining written notes concerning the delivery, a signature or other form of proof of delivery, and a voice proof of delivery described in further detail below. This information can be obtained by any suitable technique. In an example, this information is received by a portable optical scanning and communications device. In further examples, this information can be obtained by one or more other suitable devices.

The information collected during the package receipt stage 102, the package processing stage 104, and the package delivery stage 106 are sent through a communications system 108 to a central storage 110. In some examples, the communications system includes wireless communications that are implemented by various techniques. In an example, packages are to be delivered to areas of a facility where wireless communications are unavailable. In some examples, the below-described systems and methods accommodate such gaps in wireless availability as is described below. The central storage 110 receives and stores the above-described data for further use as is known by practitioners of ordinary skill in the relevant arts.

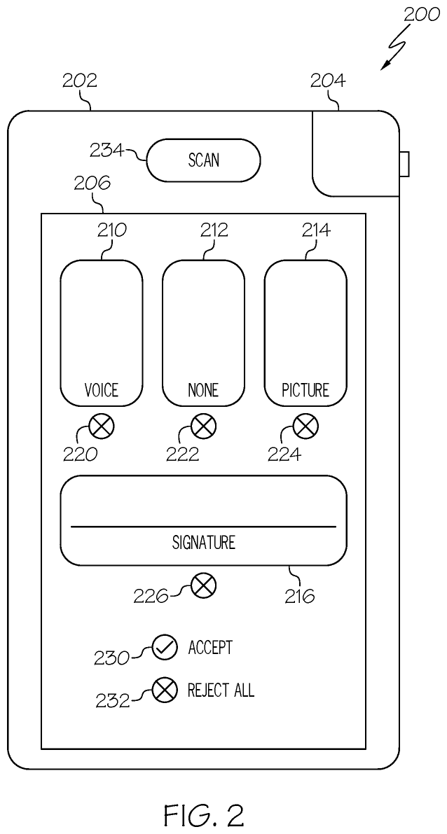

FIG. 2 illustrates a proof of delivery receiver user interface 200, according to an example. The proof of delivery receiver user interface 200 is an example of a user interface presented by an application used to obtain proof of delivery. In some examples, this user interface is presented on a touch input screen 208 such as is found on portable handheld device 202 including smart phones, tablets, other portable computing devices, purpose build hardware, other suitable hardware, or combinations of these, when a delivery person is providing a package to the addressee of the package.

The illustrated handheld device 202 includes a camera 204 and a scan button 234. In various examples, the camera 204 is able to capture various images for various purposes, including to support obtaining proof of delivery information. In some examples, the camera 204 is able to capture an image of a label on a package in order to scan the label, based on a user pressing the scan button, to identify the package. The camera 204 is also able to capture other images, videos, or combinations thereof, in order to support providing picture or video based proof of delivery recordings.

The proof of delivery receiver user interface 200 presents a number of icons that allow the selection of a type of proof of delivery that is to be obtained. The proof of delivery receiver user interface 200 includes a voice icon 210, a picture icon 214, a none icon 212, and a signature icon 216. Selecting the voice icon 210 allows a voice recording to be captured to support obtaining a voice proof of delivery. Selecting the picture icon 214 allows images to be captured to support a photo based proof of delivery to be provided. In some examples, a video is also optionally able to be captured to support obtaining a proof of delivery. Selecting the “none” icon 212 allows the delivery to be recorded but without obtaining proof of delivery from the person to whom the package is given. Individual reject icons 220, 222, 224, and 226 allow rejecting or unselecting a particular type of proof of delivery and allow re-selection of any type of proof of delivery to be accepted. The voice reject icon 220 rejects, e.g., erases a recorded voice proof of delivery. The picture reject icon 224 rejects, e.g., erases, captured pictures, and the signature reject icon 225 rejects, e.g., erases, obtained signatures. Selecting the reject all icon 232 cancels the current selection and selecting the accept icon 230 accepts an acquired proof of delivery and ends the proof of delivery reception processing.

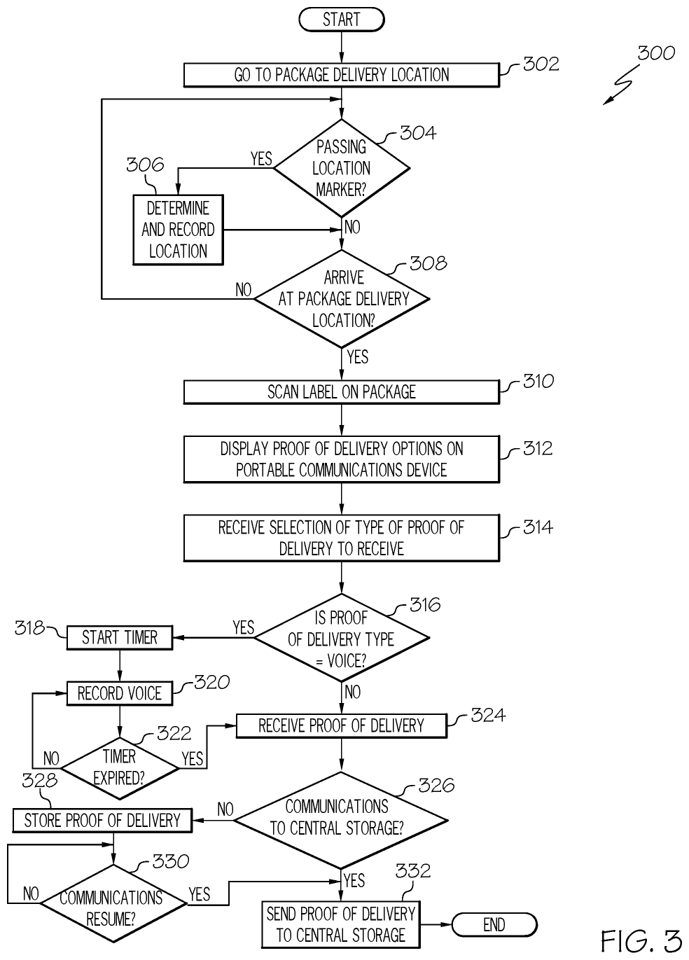

FIG. 3 illustrates a package delivery process 300, according to an example. The package delivery process 300 depicts operations performed in part by a proof of delivery processor in the course of delivering a package to its destination, such as the addressee of the package or the location of the addressee where someone is able to accept that package and provide proof of delivery for the deliverer.

The package delivery process 300 begins by going, at 302, to a package delivery location. That location is able to be any suitable type of location such as an office number in an office building, an address of a building, any suitable location, or combinations of these.

While going to the package delivery location, determinations are made, at 304, if a location marker is being passed by the deliverer. As discussed above, location markers are able to be of any suitable type, such as optically scanned barcodes, NFC or RFID transponders, Bluetooth or WiFi transmitters, other devices, or any combination of these. If a location marker is being passed, the location is determined based on the location marker and is recorded at 306.

After determining and recording position, or if no location marker was passed, a determination is made, at 308, as to whether the deliverer has arrived at the package delivery location. Such a determination is able to be made by any suitable technique. In various examples, the determination is based on the deliverer scanning the package label, by selecting an icon on a portable scanning and communications device, such as a smart phone, selecting an icon to select a type of proof of delivery, by any other technique, or by combinations of these. If it is determined that the deliverer has not arrived at the package delivery location, processing returns to determining, at 304, whether a location marker is being passed.

If it is determined, at 308, that the deliverer has arrived at the delivery location, the process includes scanning, at 310, the label on the package and displaying, at 312, proof of delivery options on the portable communications device. In some examples, one or more of these may be a basis for determining that the deliverer has arrived at the package delivery location. In further examples, other mechanisms are able to be included as a basis for determining that the deliverer has arrived at the delivery location.

A display of proof of delivery options is provided on the portable communications device 312, and a selection of the type of proof of delivery to receive is received at 314. An example of such a display is discussed above with regards to proof of delivery receiver user interface 200, and the selection in such an example is provided by touching an icon on that display that is associated with the type of proof of delivery that is desired to be provided.

A determination is made, at 316, as to whether the selected type of proof of delivery is a voice recording. If a voice-based proof of delivery is selected in one example, a short time duration audio recording is started. A timer is started at 318, and the proof of delivery is received, at 324, by capturing a fixed-length short recording for a determined period of time, such as a recording limited to 10 seconds that allows the recipient to announce his or her name and say the number of packages delivered. In an example, the recording continues until a determination is made, at 322, that the timer started at 318 has expired.

In some examples, prior to starting the timer for the fixed-length short recording, the recording process starts with the display of a decrementing pre-audio capture timer that indicates the time remaining until the audio capture is to be started in order to alert the package recipient as to when to start talking. After the countdown timer expires, the timer for the fixed-length short recording is started. The length of the pre-audio capture timer and the length of recording can be configured in the system.

A proof of delivery is received at 324. The proof of delivery is able to be the fixed-length short recording described above, or one of the other above-described types of proof of delivery. In some examples, selection of the picture icon 214 causes an image to be captured as a proof of delivery. For example, an image of the package at the door of the addressee could be captured as such a proof of delivery.

A determination is made, at 326, as to whether communications exist to the central storage. The handheld device, in some examples, determines if a data communications link is “up” and is providing data communications with the central server to which the voice proof of delivery is to be sent. If it is determined that there are no data communications to the central server, the proof of delivery, such as the voice recording, is stored at 328, and the state of data communications to the server is continued to be monitored at 330. Once it is determined that data communications have resumed and are again available to the central server, or if communications were available as determined at 326, the proof of delivery, such as the voice recording, is sent to the central server at 330. The package delivery process 300 then ends.

In an example, monitoring the state of data communications includes determining if a Wi-Fi link, cellular data link, other wireless data communications link, or combinations of these, are present and able to communicate with the central server. In some examples, sending the voice proof of delivery also includes sending one or more other parts of the above described assembled data that can include, but is not limited to, the time and date of the recording, an identifier of the handheld device, an identifier of the package, and an identifier of the delivery person. Examples that include processing to allow handheld devices to store data until a determination is made that a data communications link is restored can advantageously provide more timely reporting of delivery status relative to systems where a handheld device accumulates a number of delivery status information items and has to perform an explicit “synchronization” with a central server.

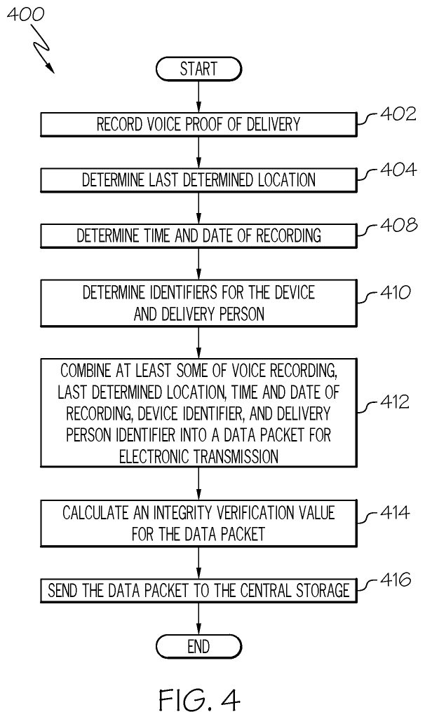

FIG. 4 illustrates a voice proof of delivery packet creation process 400, according to an example. In some examples, various data items are determined or created in association with a voice proof of delivery, and those data items are assembled into a data packet to be sent to the central storage, such as the above described central storage 110.

The voice proof of delivery packet creation process 400 begins by recording, at 402, the voice proof of delivery. An example of this recording is described above with regards to the recording at 320 of the package delivery process 300.

The last determined location of the deliverer, as of the time of recording the voice proof of delivery, is determined at 404. An example of determining the last determined location is discussed above with regards to the determining and recording position at 306 of the package delivery process.

A time and date of the voice recording is determined, at 408, and identifiers for the portable scanning and communications device and the delivery person are determined, at 410. Such determinations are able to be made by any suitable technique, such as by a real-time clock maintained by the portable scanning and communications device and identification information that is programmed into the portable scanning and communications device.

In various examples, at least some of the voice recording, last determined location, time, and date of the recording, the device identifier, and delivery person identifier are combined, at 412, into a data packet for electronic transmission. In some examples, all of these data items are combined into the data packet. In further examples, only some of these data items are combined into the data packet. Selection of which items to combine into the data packet is able to be based on any suitable technique, such as the configuration of the device, requests by a remote device, other techniques, or combinations of these.

In some examples, a digital signature or other integrity verification value is calculated, at 414, after the recording is made. In some examples, a digital signature or other integrity verification hash value is calculated over a data set that includes the data in the audio recording as well as other data such as the time and date of the recording, an identifier of the handheld device, an identifier of the package, and an identifier of the delivery person. This assembled data, along with the digital signature or other integrity verification hash, is sent, at 416, to the central storage for storage in association with the delivery transaction in order to allow subsequent retrieval by interested parties. The voice proof of delivery packet creation process 400 then ends.

In some examples, a package that has been delivered and a proof of delivery is received in one form, and then afterwards that same package can be redelivered to another person and proof of delivery is received in another form from that second person. For example, a package is able to be delivered by a first delivery agent to a first-person in error, but where that first-person provides a voice proof of delivery. That first person is then able to contact the delivery service to notify them of the error, and the delivery service is able to return to the first person and take the package from the first person and redeliver it to a second person. Proof of delivery to that second person is then obtained when the package is received by the second person. In various examples, that second person is able to give a physical signature proof of delivery, a voice proof of delivery, or other forms of proof of delivery. The person who redelivers the package from the first person to the second person in some examples is able to be a different delivery agent than the first delivery agent and thus will have a different delivery person's device. In such an example, all of the different proofs of delivery for that package, which may include proofs of delivery in any combination of the same form or different forms, are sent to a central server, such as the PS/SHIP PS/REC Database, which is able to receive data from the central storage 110 described above. These multiple proofs of delivery for that package, which are able to be accepted by the same or different delivery person's devices, are then able to be assembled at that server and properly sorted and arranged for presentation in order to review the delivery history of that package.

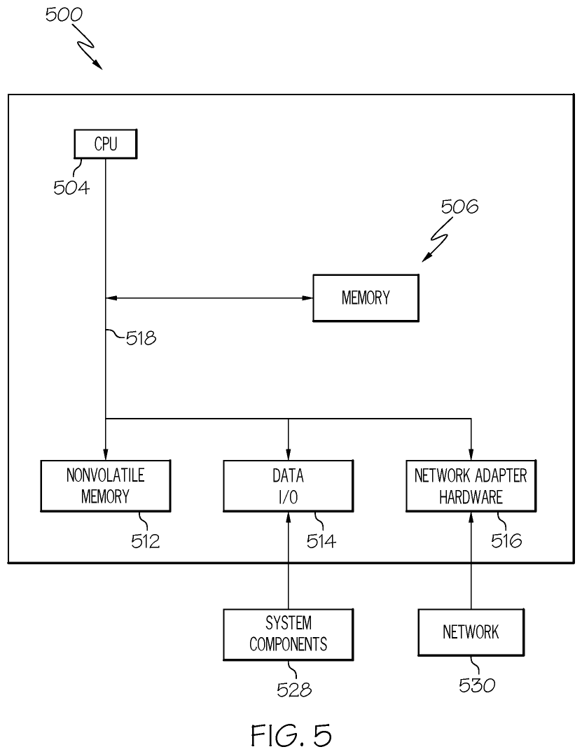

FIG. 5 illustrates a block diagram illustrating a processor 500 according to an example. The processor 500 is an example of a processing subsystem that is able to perform any of the above-described processing operations, control operations, other operations, or combinations of these.

The processor 500 in this example includes a CPU 504 that is communicatively connected to a main memory 506 (e.g., volatile memory), a non-volatile memory 512 to support processing operations. The CPU is further communicatively coupled to a network adapter hardware 516 to support input and output communications with external computing systems such as through the illustrated network 530.

The processor 500 further includes a data input/output (I/O) processor 514 that is able to be adapted to communicate with any type of equipment, such as the illustrated system components 528. The data input/output (I/O) processor in various examples is able to be configured to support any type of data communications connections including present day analog and/or digital techniques or via a future communications mechanism. A system bus 518 interconnects these system components.

Information Processing System

The present subject matter can be realized in hardware, software, or a combination of hardware and software. A system can be realized in a centralized fashion in one computer system or in a distributed fashion where different elements are spread across several interconnected computer systems. Any kind of computer system—or other apparatus adapted for carrying out the methods described herein—is suitable. A typical combination of hardware and software could be a general-purpose computer system with a computer program that, when being loaded and executed, controls the computer system such that it carries out the methods described herein.

The present subject matter can also be embedded in a computer program product, which comprises all the features enabling the implementation of the methods described herein, and which—when loaded in a computer system—is able to carry out these methods. A computer program in the present context means any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer-readable medium allowing a computer to read data, instructions, messages or message packets, and other computer-readable information from the computer-readable medium. The computer-readable medium may include computer-readable storage medium embodying non-volatile memory, such as read-only memory (ROM), flash memory, disk drive memory, CD-ROM, and other permanent storage. Additionally, a computer medium may include volatile storage such as RAM, buffers, cache memory, and network circuits. Furthermore, the computer-readable medium may comprise computer-readable information in a transitory state medium such as a network link and/or a network interface, including a wired network or a wireless network, that allow a computer to read such computer-readable information. In general, the computer-readable medium embodies a computer program product as a computer-readable storage medium that embodies computer-readable program code with instructions to control a machine to perform the above-described methods and realize the above-described systems.

### NON-LIMITING EXAMPLES

Although specific embodiments of the subject matter have been disclosed, those having ordinary skill in the art will understand that changes can be made to the specific embodiments without departing from the spirit and scope of the disclosed subject matter. The scope of the disclosure is not to be restricted, therefore, to the specific embodiments, and it is intended that the appended claims cover any and all such applications, modifications, and embodiments within the scope of the present disclosure.

What is claimed is:

1. A computer-implemented method on a portable scanning and communications device for receiving and reporting a voice confirmation of a package delivery, the method comprising:
scanning, by an operator using a portable scanning and communications device, a package label to identify a package and begin a delivery confirmation process;
starting a time-limited audio recording of a recorded voice proof of delivery that records audio for a determined period of time, where a duration of the time-limited audio recording is configurable;
storing, at the portable scanning and communications device, the time-limited audio recording; and
sending the time-limited audio recording from the portable scanning and communications device to a central storage.

2. The method of claim 1, further comprising, based on scanning a package label, starting and displaying, on the portable scanning and communications device, a decrementing pre-audio capture timer indicating a time remaining until audio capture is started, and
wherein the time-limited audio recording of the recorded voice proof of delivery is started after the decrementing pre-audio capture timer expires.

3. The method of claim 1, further comprising:
calculating an integrity verification value of the time-limited audio recording; and
sending the integrity verification value to the central storage based on sending the time-limited audio recording from the portable scanning and communications device to the central storage.

4. The method of claim 1, further comprising determining that a data communications link to the central storage is not available from the portable scanning and communications device, wherein the storing the time-limited audio recording and the sending the time-limited audio recording are based on determining resumption of data communications with the central storage.

5. The method of claim 1, further comprising:
interacting with a location marker located within a building to determine a location of the portable scanning and communications device; and
sending, based on determining the location of the portable scanning and communications device and based on sending the time-limited audio recording, an indication of the location of the portable scanning and communications device to the central storage.

6. The method of claim 5, wherein the location marker comprises any one or more of optically scanned barcodes, NFC or RFID transponders, Bluetooth or WiFi transmitters.

7. The method of claim 1, further comprising associating a time and date of recording of the time-limited audio recording, a identifier of the portable scanning and communications device, and a delivery person identifier with the time-limited audio recording, and
wherein the sending the time-limited audio recording further comprises sending the time and date of recording of the time-limited audio recording, a device identifier and the delivery person identifier with the time-limited audio recording.

8. The method of claim 7, further comprising:
calculating an integrity verification value of a combination of a time and date of recording of the time-limited audio recording, the device identifier, the delivery person identifier, and the time-limited audio recording; and
sending, based on determining resumption of data communications with the central storage, the integrity verification value to the central storage.

9. A portable scanning and communications device for receiving and reporting a voice confirmation of a package delivery, the portable scanning and communications device comprising:
a processor;
a memory communicatively coupled to the processor;
a proof of delivery processor that, when operating, is configured to:
scan, by an operator using a portable scanning and communications device, a package label to identify a package and begin a delivery confirmation process;
start a time-limited audio recording of a recorded voice proof of delivery that records audio for a determined period of time, where a duration of the time-limited audio recording is configurable;
store, at the portable scanning and communications device, the time-limited audio recording; and
send the time-limited audio recording from the portable scanning and communications device to a central storage.

10. The portable scanning and communications device of claim 9, further comprising:
a display, and
where the proof of delivery processor is further configured to, when operating, based on a scan of a package label, start and display, on the display, a decrementing pre-audio capture timer indicating a time remaining until audio capture is started, and
wherein the time-limited audio recording of the recorded voice proof of delivery is started after the decrementing pre-audio capture timer expires.

11. The portable scanning and communications device of claim 9, where the proof of delivery processor is further configured to, when operating:
calculate an integrity verification value of the time-limited audio recording; and
send the integrity verification value to the central storage based on sending the time-limited audio recording from the portable scanning and communications device to the central storage.

12. The portable scanning and communications device of claim 9, where the proof of delivery processor is further configured to, when operating, determine that a data communications link to the central storage is not available from the portable scanning and communications device, wherein the proof of delivery processor is further configured to, when operating, store the time-limited audio recording and send the time-limited audio recording based on a determination of a resumption of data communications with the central storage.

13. The portable scanning and communications device of claim 9, where the proof of delivery processor is further configured to, when operating:
interact with a location marker located within a building to determine a location of the portable scanning and communications device; and
send, based on determining the location of the portable scanning and communications device and based on sending the time-limited audio recording, an indication of the location of the portable scanning and communications device to the central storage.

14. The portable scanning and communications device of claim 13, wherein the location marker comprises any one or more of optically scanned barcodes, NFC or RFID transponders, Bluetooth or WiFi transmitters.

15. The portable scanning and communications device of claim 9, where the proof of delivery processor is further configured to, when operating, associate a time and date of recording of the time-limited audio recording, a identifier of the portable scanning and communications device, and a delivery person identifier with the time-limited audio recording, and
wherein the proof of delivery processor is further configured to, when operating, send the time-limited audio recording by at least sending the time and date of recording of the time-limited audio recording, a device identifier and the delivery person identifier with the time-limited audio recording.

16. The portable scanning and communications device of claim 15, where the proof of delivery processor is further configured to, when operating:
calculate an integrity verification value of a combination of a time and date of recording of the time-limited audio recording, the device identifier, the delivery person identifier, and the time-limited audio recording; and
send, based on a determination of a resumption of data communications with the central storage, the integrity verification value to the central storage.

17. A computer program product for receiving and reporting a voice confirmation of a package delivery, the computer program product comprising:
a computer readable storage medium having computer readable program code embodied therewith, the computer readable program code comprising instructions for:
scanning, by an operator using a portable scanning and communications device, a package label to identify a package and begin a delivery confirmation process;
starting a time-limited audio recording of a recorded voice proof of delivery that records audio for a determined period of time, where a duration of the time-limited audio recording is configurable;
storing, at the portable scanning and communications device, the time-limited audio recording; and
sending the time-limited audio recording from the portable scanning and communications device to a central storage.

18. The computer program product of claim 17, computer readable program code further comprises instructions for, based on scanning a package label, starting and displaying, on the portable scanning and communications device, a decrementing pre-audio capture timer indicating a time remaining until audio capture is started, and
wherein the instructions for time-limited audio recording of the recorded voice proof of delivery are started after the decrementing pre-audio capture timer expires.

19. The computer program product of claim 17, where the computer readable program code further comprises instructions for:
calculating an integrity verification value of the time-limited audio recording; and
sending the integrity verification value to the central storage based on sending the time-limited audio recording from the portable scanning and communications device to the central storage.

20. The computer program product of claim 17, where the computer readable program code further comprises instructions for determining that a data communications link to the central storage is not available from the portable scanning and communications device, wherein the instructions for storing the time-limited audio recording and the sending the time-limited audio recording are performed based on determining resumption of data communications with the central storage.
